(19) United States
(12) Patent Application Publication
(10) Pub. No.: US 2014/0137090 A1
(43) Pub. Date: May 15, 2014

(54) SYSTEM AND METHOD OF CROSS-PLATFORM SOFTWARE DEVELOPMENT AND COMPILATION

(71) Applicant: SGN GAMES, INC., Los Angeles, CA (US)

(72) Inventors: Aber Whitcomb, Marina Del Ray, CA (US); Jesus Lopez Amaro, Alameda, CA (US); Joshua J.Z. Yguado, Los Angeles, CA (US)

(73) Assignee: SGN Games, Inc., Los Angeles, CA (US)

(21) Appl. No.: 13/674,856

(22) Filed: Nov. 12, 2012

(51) Int. Cl. G06F 9/44

(52) U.S. Cl. 717/163

(57) ABSTRACT

Methods of development and compilation of cross-platform software are provided. Through the use of platform-specific libraries, software can be written using only platform-independent instructions and then compiled for one or more different platform targets. In the compilation process, a compiler can obtain a target platform. Then, the compiler can select a platform-specific library associated with that target platform. A platform-independent instruction can then be obtained by parsing source code, for example. The compiler can then link the platform-independent instruction with a platform-specific instruction of the selected platform-specific library. This can allow cross-platform software to be written using only platform-independent instructions, and platform-specific instructions can be linked automatically when compiling the software for a specific target platform.

### FIELD OF THE DISCLOSURE

This relates generally to the development and compilation of cross-platform software.

### BACKGROUND OF THE DISCLOSURE

As competing software platforms such as Android™, iOS, and the web browser have gained prominence, cross-platform software development has become increasingly important. Solutions such as Adobe AIR® can allow developers to compile a single code base for multiple platform targets. However, such solutions can be limited in that the software must be kept relatively simple. If platform-specific functions such as advanced graphics, different input/output (I/O) interfaces, and application store purchases are to be included, the software may need to be re-written with native code for each specific platform, increasing development overhead.

### SUMMARY OF THE DISCLOSURE

This relates to the development and compilation of cross-platform software. Through the use of platform-specific libraries, software can be written using only platform-independent instructions and then compiled for one or more different platform targets. In the compilation process, a compiler can obtain target platform information, such as a name or identifier of a target platform. For example, the target can be retrieved from a configuration file. Then, the compiler can select a platform-specific library associated with that target platform. The platform-specific library may include instructions specific to an application platform such as Android™, iOS, or the web browser. A platform-independent instruction can then be obtained by parsing source code, for example. The compiler can then link the platform-independent instruction with a platform-specific instruction of the selected platform-specific library. This can allow cross-platform software to be written using only platform-independent instructions, and platform-specific instructions can be linked automatically when compiling the software for a specific target platform.

### BRIEF DESCRIPTION OF THE DRAWINGS

FIG. 1 illustrates stages of development of cross-platform software according to examples of the disclosure.

FIG. 2 illustrates a method of compiling cross-platform software, including linking platform-independent instructions with platform-specific instructions, according to examples of the disclosure.

FIG. 3 illustrates an exemplary interface of slot machine game software according to examples of the disclosure.

FIG. 4A illustrates a method of a purchase interaction with a first target platform according to examples of the disclosure.

FIG. 4B illustrates a method of a purchase interaction with a second target platform according to examples of the disclosure.

FIG. 5 is a block diagram illustrating an exemplary API architecture, which may be used in some examples of the disclosure.

FIG. 6 illustrates an exemplary software stack of an API according to examples of the disclosure.

FIG. 7 illustrates a system for cross-platform software development and compilation according to examples of the disclosure.

### DETAILED DESCRIPTION

Examples of the disclosure relate to the development and compilation of cross-platform software. Through the use of platform-specific libraries, software can be written using only platform-independent instructions and then compiled for one or more different platform targets. In the compilation process, a compiler can obtain target platform information, such as a name or identifier of a target platform. For example, the target can be retrieved from a configuration file. Then, the compiler can select a platform-specific library associated with that target platform. The platform-specific library may include instructions specific to an application platform such as Android™ iOS, or the web browser. A platform-independent instruction can then be obtained by parsing source code, for example. The compiler can then link the platform-independent instruction with a platform-specific instruction of the selected platform-specific library. This can allow cross-platform software to be written using only platform-independent instructions, and platform-specific instructions can be linked automatically when compiling the software for a specific target platform.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

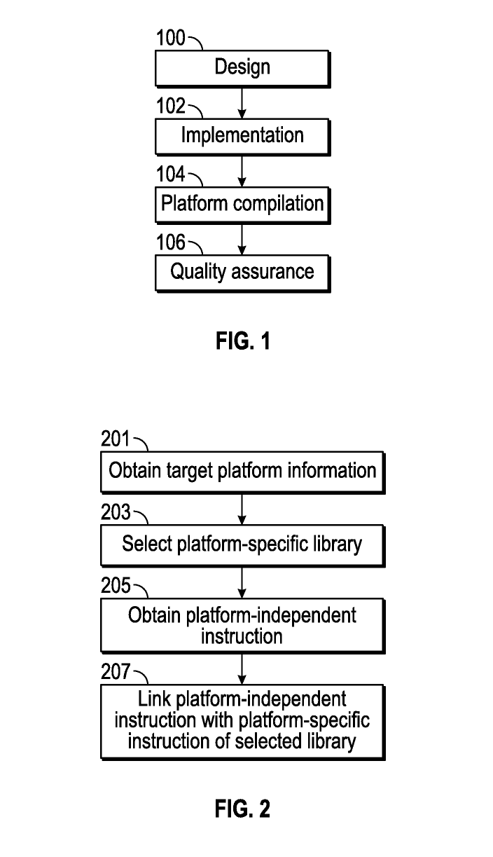

FIG. 1 illustrates stages of development of cross-platform software according to examples of the disclosure. Software can be designed to be cross-platform (100) with respect to hardware, software, or both. For example, with respect to hardware (such as for hardware platform-specific instructions), the software design process can include developing for multiple possible displays with different screen sizes, aspect ratios, and pixel resolutions. Resizable user interface (UI) elements can be included to allow for adaptation to multiple possible displays. Additionally, the software can be designed to account for multiple possible user input methods. For example, the software can be designed for both mouse input and touch screen input, such that the software can be used on mobile devices with touch screens and personal computers with mouse input.

The cross-platform software can be implemented (102). Implementation of the cross-platform software can include writing the software for a development platform designed to compile software for multiple target platforms. For example, software designed to be cross-platform with respect to software (such as for software platform-specific instructions), software can be written in ActionScript® for the Adobe AIR® development platform and then compiled for multiple software platforms, such as the web, Android™, and iOS. Software compiled for the web can use technologies such as HTML5, Adobe Flash, and Javascript, among other possibilities. Additionally, custom application libraries can be provided for various development platforms. Such libraries can include a physics engine, a particle engine, an artificial intelligence engine, and/or a framework for advanced graphics acceleration, among other possibilities. The custom application libraries can be developed to provide performance benefits on one or more target platforms.

The cross-platform software can be compiled for one or more target platforms (104). A compiler such as Adobe AIR® can compile a single code base for one or more target platforms. Additionally, the compiler can link against platform-specific libraries, as discussed below with reference to FIG. 2. These libraries can provide a single Application Programming Interface (API) to various platform-specific features, such as chipset graphic acceleration, sound output, payments, social networking, analytics, and advertising. Cross-platform compilers can support platform-specific native code. For example, Adobe AIR® can support native code written in Java for Android™ applications and Objective C for iOS applications. Such native code can be used in various platform-specific libraries, so that software can be developed in a platform-independent manner with any platform-specific functions being handled by the libraries, without the single code base having to incorporate the native code itself. Platform-independent instructions can be linked to platform-specific instructions when the code is compiled for a target platform.

The cross-platform software can be tested on one or more target platforms for quality assurance (106). Performance testing tools can be used to ensure that software runs at an acceptable speed and with high-quality graphics. Additionally, tests can be automated on each platform to ensure that the software is rendered properly on displays with different screen sizes, aspect ratios, and pixel resolutions. Input tests can be automated to test whether UI elements that are intended to be selectable by a user can actually be selected on each target platform and display type.

FIG. 2 illustrates a method of compiling cross-platform software, including linking platform-independent instructions with platform-specific instructions, according to examples of the disclosure. Each possible target platform may have very different ways of performing common functions. For example, Android™ and iOS have application stores Google Play® and iTunes®, respectively. Each application store can allow an application to route purchases made within the application through the application store to simplify billing the user for the purchase. However, a purchase instruction to Google Play® may be different and/or have different arguments than a purchase instruction to iTunes®. Accordingly, an API may be provided with a platform-independent purchase instruction. During compilation for a target platform, the platform-independent purchase instruction may be linked to a platform-specific purchase instruction for the target platform. For example, a platform-independent purchase instruction can be linked to a Google Play® purchase instruction when compiling for the Android™ platform. The same platform-independent purchase instruction can be linked to an iTunes® purchase instruction when compiling for the iOS platform.

Target platform information can be obtained (201). Target platform information may include a name or identifier of a target platform, among other possibilities. A target platform may be determined based on the target platform information. Target platforms may include operating systems (e.g., iOS, Android™ etc.), application stores (e.g., Google Play®, iTunes®, Amazon® Appstore, etc.), social media platforms (e.g., Facebook®, Twitter®, etc.), advertising platforms (e.g., ChartBoost®, DoubleClick Ad Exchange®, MoPub®, etc.), and/or analytics platforms (e.g., Kontagent®, etc.), among other possibilities. Additionally, a target platform may include any combination of the above. For example, a target platform may include an operating system and an application store such as Amazon® Appstore for Android™ In another example, a target platform can include Google Play® for Android™. The target platform may include different variations on one platform. For example, one target platform can be the desktop web version of Facebook®, whereas another target platform can be a mobile version of Facebook®, either for the mobile web or for a specific mobile platform.

Obtaining the target platform information can include obtaining the target platform information based on user input and/or retrieving a name or identifier of a stored target platform, among other possibilities.

A platform-specific library can be selected based on the target platform (203). The library can be selected from a plurality of platform-specific libraries, each corresponding to an application platform. In some examples, a platform-specific library corresponding to the target platform can be selected. For example, a plurality of platform-specific libraries can include libraries for each of the iOS and Android™ platforms. If the target platform is Android™, then the library corresponding to the Android™ platform can be selected. Additionally, one or more libraries for each platform may provide different functions. For example, a first platform-specific library may contain instructions related to an application store for that platform. A second platform-specific library may contain instructions related to social networking on that platform. Other libraries may contain instructions related to advertising and analytics, graphics, and sound, among other possibilities.

A platform-independent instruction can be obtained (205). A platform-independent instruction can include a purchase instruction, a social network post instruction, an advertisement display instruction, a notification instruction, and other possibilities. Obtaining the platform-independent instruction can include parsing the platform-independent instruction from source code. Alternatively, other examples of obtaining the platform-independent instruction include receiving the instruction from another software module or compiler.

The platform-independent instruction can be linked with a platform-specific instruction of the selected platform-specific library (207). Linking the two instructions can include associating the platform-independent instruction with the platform-specific instruction, such that the platform-specific instruction is executed when the platform-independent instruction is executed.

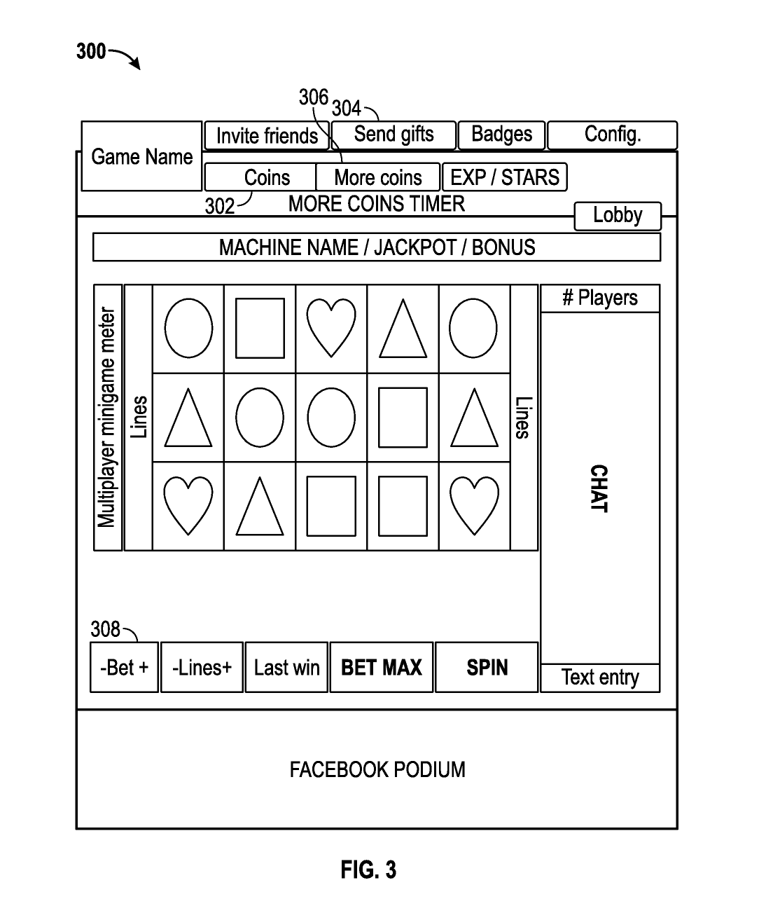

FIG. 3 illustrates an exemplary interface 300 of slot machine game software according to examples of the disclosure. Such a game can have its own currency for purchasing in-game items. As illustrated in FIG. 3, a slot machine game can have coins 302 that are used for placing bets 308 on spins of the slot machine. Coins 302 can also be used to purchase access to different slot machines or to purchase gifts 304. In some examples, in-game currency can be used to access new features, levels, and/or characters, among other possibilities. The in-game currency itself can be purchased through a platform application store. However, as discussed above, each platform can have a different platform-specific purchase instruction.

During the development of the slot machine game in FIG. 3, the “More Coins” button 306 can be associated with a platform-independent purchase instruction, such that when user input is received on the button, the platform-independent purchase instruction is called. During compilation, the platform-independent purchase instruction can be linked to a platform-specific purchase instruction for the target platform. Then, when user input is received on the button, the platform-independent purchase instruction is called, which, in turn, can call the platform-specific purchase instruction for the target platform. For example, when the slot machine game is played on iOS, the platform-independent purchase instruction can call a purchase instruction for the iTunes® store. When the game is played on Android™, the platform-independent purchase instruction can call a purchase instruction for the Google Play® store.

In another example, the slot machine game software may send a notification to a user that new slot machines are available for purchase. However, each platform may have a different instruction and arguments for sending notifications. For example, notifications in Android™ can be expanded to show additional information. The slot machine software can send a notification that new slot machines are available with expanded information that details the names of the new slot machines. The software can be written using a platform-independent notification instruction that sends all the information, including the names of the new slot machines. During compilation, the platform-independent notification instruction can be linked to a platform-specific notification instruction for the target platform. For Android™, the platform-specific instruction can include passing on the names of the new slot machines as additional information for an expanded notification. For iOS, the platform-specific instruction can include discarding the names of the new slot machines and only passing on a notification that new slot machines are available. When new slot machines become available for purchase, the platform-independent notification instruction can be called, which, in turn, can call the platform-specific notification instruction appropriate for the target platform.

In some examples, a platform may display a notification pushed to an electronic device from an external server. Such notifications may be known as push notifications. When the platform displays a notification and accepts user input selecting the notification, the platform can send notification information to the application associated with the notification. The platform can call a notification instruction of the platform-specific library, which can send the notification information to the cross-platform software by calling a platform-independent instruction of the software. In some examples, each platform may format the notification information differently and/or send different notification information. However, each platform-specific library can account for these differences by discarding or ignoring any information that would not be offered by every platform and re-formatting the information to a standard format. For example, if a first target platform sends notification information including a payload, a message and then a title, and a second target platform sends notification information including a message and a payload, then a platform-independent instruction can only receive a message and a payload because not every platform will send notification information including a title. Accordingly, the platform-specific library for the first target platform would ignore or discard the title before sending the other information to the cross-platform software through the platform-independent instruction.

In some examples, platform-independent analytics instructions may be linked to platform-specific analytics instructions in a platform-specific library. Analytics instructions can include a revenue tracking instruction that can be called when a purchase is made to track the specific item that was purchased and the amount of money for which it was purchased. Other analytics instructions can include an event tracking instruction or a social media tracking instruction. An event tracking instruction can be called to track specific events within software. For example, an event tracking instruction can be called to track that a certain level was completed by the user. A social media tracking instruction can be called to track when a user shares information from the software on a social media network.

In some examples, platform-independent advertising instructions may be linked to platform-specific advertising instructions in a platform-specific library. For example, an advertisement display instruction can be called to display an advertisement. Additionally, an advertisement completion instruction can be called when an advertisement has been completed or dismissed by a user.

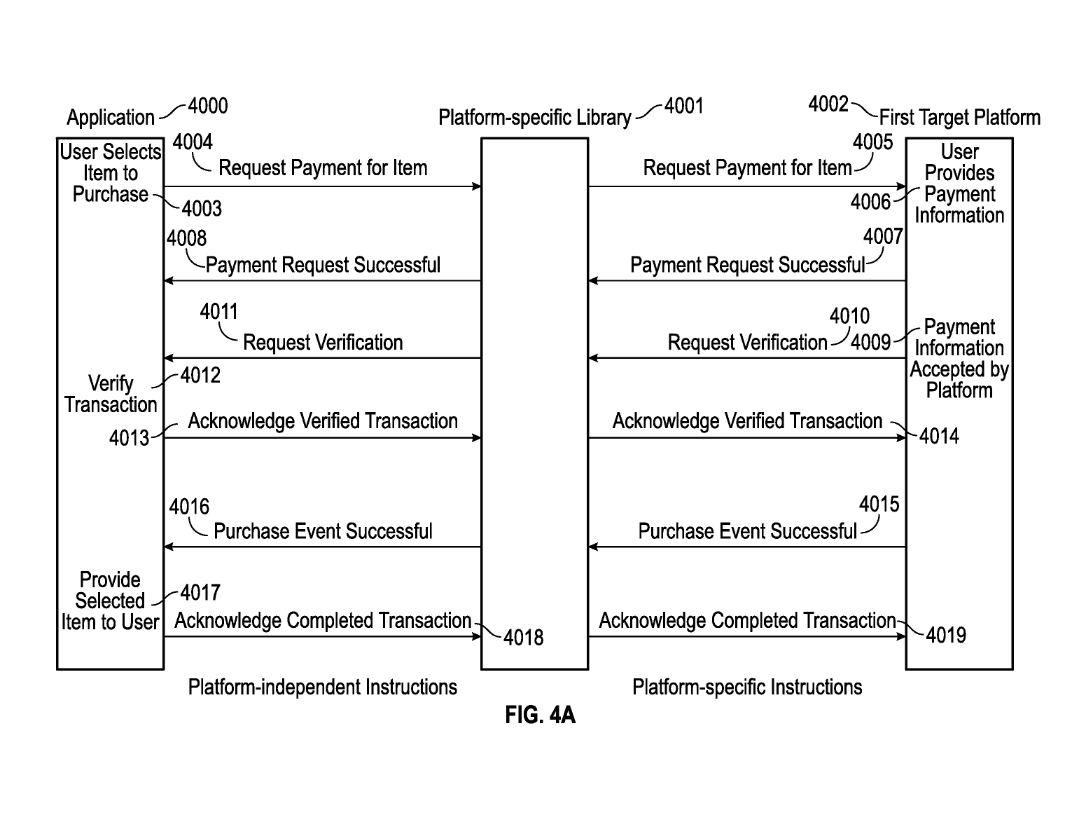

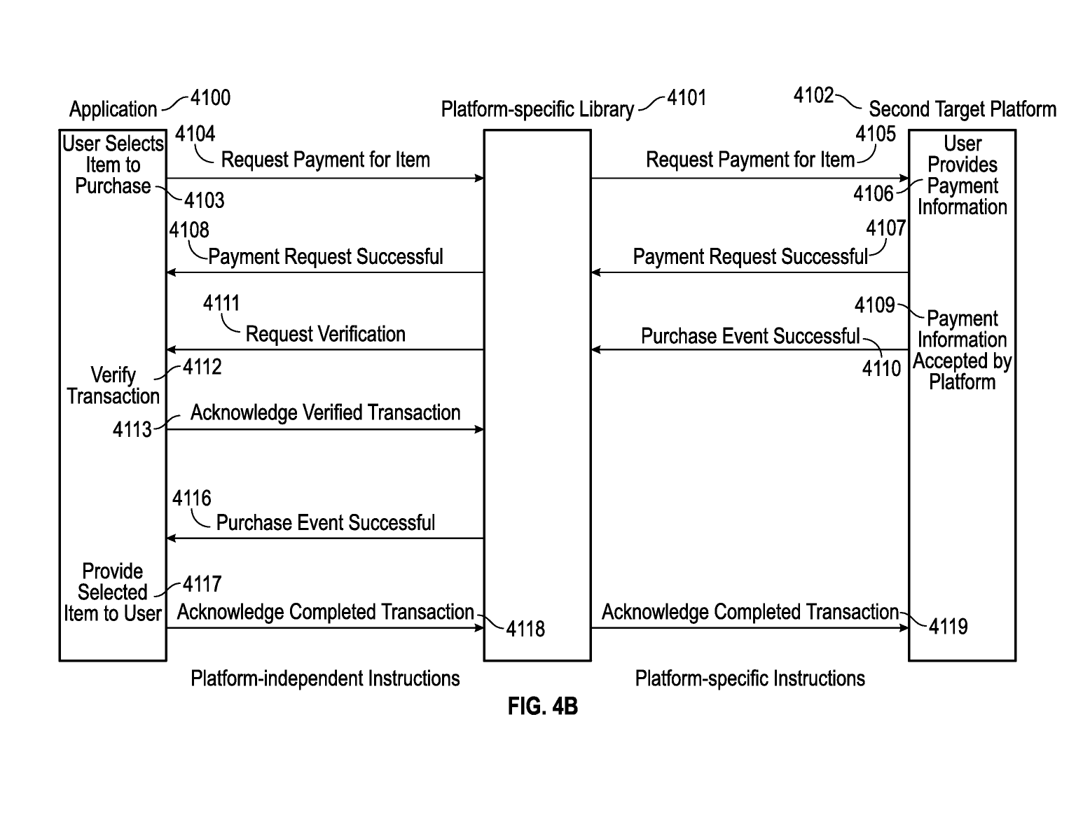

FIG. 4A illustrates an exemplary purchase interaction with a first target platform according to examples of the disclosure. An application 4000 can interact with a first target platform 4002 through a platform-specific library 4001. The instructions between the application 4000 and the platform-specific library 4001 can all be platform-independent, whereas the instructions between the platform-specific library 4001 and the first target platform 4002 can be platform-specific. Although FIG. 4A and 4B illustrate a purchase interaction, examples are not so limited and also apply to other interactions and instructions, including notifications, advertising, and analytics, among other possibilities.

In the application 4000, a user can select an item to purchase (4003), which can call an instruction of the platform-specific library 4001 that requests payment for the item (4004). In turn, the platform-specific library 4001 can call an instruction of the first target platform 4002 to request payment for the item (4005). The platform 4002 can then prompt the user for payment information, which the user can provide directly to the platform (4006). The platform 4002 can then call an instruction of the platform-specific library 4001 that the payment request was successful (4007). Such an instruction can indicate, for example, that the payment prompt was completed by the user, but not necessarily that the payment was accepted. The platform-specific library 4001 can then call an instruction of the application 4000 that the payment request was successful (4008).

The payment information provided by the user can be accepted by the platform (4009). In some examples, this can involve charging a credit or a debit card. Then, the platform 4002 can request verification of the transaction (4010). Some platforms can request transaction verification as a security measure to ensure that the application 4000 is actually interacting with the target platform 4002 and not with software that is merely posing as the target platform to allow for purchases without payment, for example. The platform-specific library 4001 can then call a platform-independent request for verification (4011). The application 4000 can verify the transaction (4012). In some examples, verifying the transaction can include sending information of the transaction to a verification backend using public key cryptography. The application 4000 can acknowledge the verified transaction to the platform-specific library (4013), which passes the acknowledgement through to the platform (4014).

After verification, the platform 4002 can call an instruction that the purchase event was successful (4015) and the platform-specific library (4001) can pass that to the application (4016). The application 4000, based on information that the transaction is complete, can provide the selected item to the user (4017). Then, the completed transaction can be acknowledged to the platform-specific library (4018) and on to the platform (4019).

FIG. 4A illustrates an exemplary purchase interaction with a second target platform according to examples of the disclosure. In this example, the second target platform does not request verification of the transaction. However, the application 4100 can call and respond to the same platform-independent instructions as in FIG. 4A. Accordingly, the platform-specific library 4101 can respond to platform-independent instructions from the application 4100 and call platform-independent instructions of the application 4100 as if the second target platform does, in fact, request verification of the transaction.

After the payment information is accepted by the platform (4109), the platform 4102 can call a purchase event successful instruction of the platform-specific library (4110). The application 4100 expects to receive a verification request at this point, so in response to the purchase event successful instruction (4110), the platform-specific library 4101 can call an instruction of the application that requests verification of the transaction (4111). The application 4100 can verify the transaction (4112) and acknowledge the verified transaction (4113). In response to the acknowledgement, the platform-specific library 4101 does not need to interact with the platform 4102 and can instead send a purchase event successful instruction to the application (4116). This example illustrates how the methods of each platform-specific library can be tailored to each platform but still provide the same platform-independent functionality to each platform.

In FIG. 4A, the acknowledge verified transaction instruction 4013 of the platform-specific library 4001 can call the acknowledge verified transaction instruction 4014 of the first target platform 4002. This can be contrasted with FIG. 4B, wherein the acknowledge verified transaction instruction 4113 of the platform-specific library 4001 can call the purchase event successful instruction 4116 of the application 4100.

Note that the platform-independent instructions of FIG. 4A can be identical to the platform-independent instructions of FIG. 4B. However, because the platform-specific library 4001 of FIG. 4A is different from the platform-specific library 4101 of FIG. 4B, the interactions with the target platform are different.

The examples discussed above can be implemented in one or more Application Programming Interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API can allow a developer of an API-calling component (which may be a third party developer) to leverage specified features, such as those described above, provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some examples, the API-implementing component may provide more than one API, each providing a different view of the functionality implemented by the API-implementing component, or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other examples the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some examples, an API may allow a client program to use the services provided by a Software Development Kit (SDK) library. In other examples an application or other client program may use an API provided by an Application Framework. In these examples the application or client program may incorporate calls to functions or methods provided by the SDK and provided by the API or use data types or objects defined in the SDK and provided by the API. An Application Framework may in these examples provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one example, call APIs from different providers such as a set of APIs from an OS provider and another set of APIs from a plug-in provider and another set of APIs from another hardware or software provider.

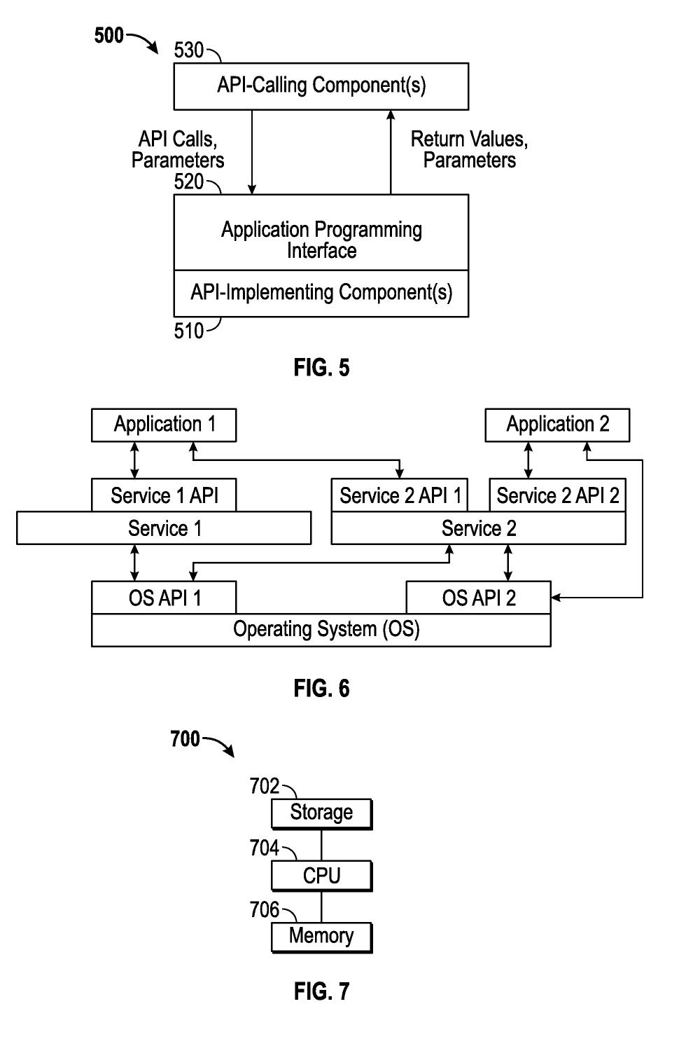

FIG. 5 is a block diagram illustrating an exemplary API architecture, which may be used in some examples of the disclosure. As shown in FIG. 5, the API architecture 500 includes the API-implementing component 510 (e.g., an operating system, a library, a device driver, an API, an application program, software or other module) that implements the API 520. The API 520 specifies one or more functions, methods, classes, objects, protocols, data structures, formats and/or other features of the API-implementing component that may be used by the API-calling component 530. The API 520 can specify at least one calling convention that specifies how a function in the API-implementing component receives parameters from the API-calling component and how the function returns a result to the API-calling component. The API-calling component 530 (e.g., an operating system, a library, a device driver, an API, an application program, software or other module), makes API calls through the API 520 to access and use the features of the API-implementing component 510 that are specified by the API 520. The API-implementing component 510 may return a value through the API 520 to the API-calling component 530 in response to an API call.

It will be appreciated that the API-implementing component 510 may include additional functions, methods, classes, data structures, and/or other features that are not specified through the API 520 and are not available to the API-calling component 530. It should be understood that the API-calling component 530 may be on the same system as the API-implementing component 510 or may be located remotely and accesses the API-implementing component 510 using the API 520 over a network. While FIG. 5 illustrates a single API-calling component 530 interacting with the API 520, it should be understood that other API-calling components, which may be written in different languages (or the same language) than the API-calling component 530, may use the API 520.

The API-implementing component 510, the API 520, and the API-calling component 530 may be stored in a non-transitory machine-readable storage medium, which includes any mechanism for storing information in a form readable by a machine (e.g., a computer or other data processing system). For example, a machine-readable medium includes magnetic disks, optical disks, random access memory; read only memory, flash memory devices, etc.

In the exemplary software stack shown in FIG. 6, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

FIG. 7 illustrates a system 700 for cross-platform software development and compilation according to examples of the disclosure. The system 700 can include a CPU 704, storage 702, and memory 706. The CPU 704 can perform the methods illustrated in and described with reference to FIGS. 1, 2, 4A, and 4B. Additionally, the storage 702 can store instructions for performing the methods illustrated in and described with reference to FIGS. 1 and 2. Although system 700 is illustrated with a single CPU 704, storage 702, and memory 706, the system may actually be made up of multiple networked or otherwise connected devices, including multiple CPUs, storages, and memories. The storage can be any non-transitory computer-readable storage medium, such as a solid-state drive or a hard disk drive.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A computer-implemented method of compiling cross-platform software to create an executable program, the method comprising:
obtaining target platform information comprising identifying an operating system on which the program is to be executed;
selecting at least one of a plurality of platform-specific libraries based on the identified operating system, the selected platform-specific library being associated with an application store of the identified operating system;
obtaining a platform-independent purchase instruction; and
linking the platform-independent purchase instruction with a platform-specific instruction of the selected platform-specific library, the platform-specific instruction being a purchase instruction for the application store of the identified operating system.

2. The method of claim 1, wherein obtaining the platform-independent purchase instruction includes parsing source code to obtain the instruction.

3. The method of claim 1, wherein the application store includes one of an iTunes® store and a Google Play® store.

4. The method of claim 1, wherein the plurality of platform-specific libraries includes a first library for an Android™ platform and a second library for an iOS platform.

5. The method of claim 1, wherein the selected platform-specific library contains native code for the target platform.

6. The method of claim 1, further comprising:
obtaining additional target platform information;
selecting an additional one of the plurality of platform-specific libraries based on the additional target platform information, the additional selected platform-specific library being associated with an application store of the additional target platform;
linking the platform-independent instruction with a platform-specific instruction of the additional selected platform-specific library, the platform-specific instruction being a purchase instruction for the application store of the additional target platform.

7. An electronic device, comprising:
a processor to execute instructions; and
a memory coupled with the processor to store instructions, which when executed by the processor, cause the processor to perform operations to generate an application programming interface (API) that allows an API-calling component to perform the following operations:
obtaining target platform information comprising identifying an operating system on which the API is to be executed;
selecting at least one of a plurality of platform-specific libraries based on the identified operating system, the selected platform-specific library being associated with an application store of the identified operating system;
obtaining a platform-independent purchase instruction; and
linking the platform-independent purchase instruction with a platform-specific instruction of the selected platform-specific library, the platform-specific instruction being a purchase instruction for the application store of the identified operating system.

8. The device of claim 7, wherein obtaining the platform-independent purchase instruction includes parsing source code to obtain the instruction.

9. The device of claim 7, wherein the application store includes one of an iTunes® store and a Google Play® store.

10. The device of claim 7, wherein the plurality of platform-specific libraries includes a first library for an Android™ platform and a second library for an iOS platform.

11. The device of claim 7, wherein the selected platform-specific library contains native code for the target platform.

12. The device of claim 7, the operations further comprising:
obtaining additional target platform information;
selecting an additional one of the plurality of platform-specific libraries based on the additional target platform information, the additional selected platform-specific library being associated with an application store of the additional target platform;
linking the platform-independent instruction with a platform-specific instruction of the additional selected platform-specific library, the platform-specific instruction being a purchase instruction for the application store of the additional target platform.

13. A non-transitory computer readable storage medium having stored therein instructions, which when executed by a device, cause the device to perform a method of compiling cross-platform software to create an executable program, the method comprising:
obtaining target platform information comprising identifying an operating system on which the program is to be executed;
selecting at least one of a plurality of platform-specific libraries based on the identified operating system, the selected platform-specific library being associated with an application store of the identified operating system;
obtaining a platform-independent purchase instruction; and
linking the platform-independent purchase instruction with a platform-specific instruction of the selected platform-specific library, the platform-specific instruction being a purchase instruction for the application store of the identified operating system.

14. The non-transitory computer readable storage medium of claim 13, wherein obtaining the platform-independent purchase instruction includes parsing source code to obtain the instruction.

15. The non-transitory computer readable storage medium of claim 13, wherein the application store includes one of an iTunes® store and a Google Play® store.

16. The non-transitory computer readable storage medium of claim 13, wherein the plurality of platform-specific libraries includes a first library for an Android™ platform and a second library for an iOS platform.

17. The non-transitory computer readable storage medium of claim 13, wherein the selected platform-specific library contains native code for the target platform.

18. The non-transitory computer readable storage medium of claim 13, the method further comprising:
obtaining additional target platform information;
selecting an additional one of the plurality of platform-specific libraries based on the additional target platform information, the additional selected platform-specific library being associated with an application store of the additional target platform;
linking the platform-independent instruction with a platform-specific instruction of the additional selected platform-specific library, the platform-specific instruction being a purchase instruction for the application store of the additional target platform.

19. A computer-implemented method of compiling cross-platform software to create an executable program, the method comprising:
obtaining target platform information comprising identifying an operating system on which the program is to be executed;
selecting at least one of a plurality of platform-specific libraries based on the identified operating system, the selected platform-specific library being associated with the identified operating system;
obtaining a platform-independent notification instruction; and
linking the platform-independent notification instruction with a platform-specific instruction of the selected platform-specific library, the platform-specific instruction being a notification instruction for the identified operating system.

20. The method of claim 19, further comprising:
obtaining additional target platform information;
selecting an additional one of the plurality of platform-specific libraries based on the additional target platform information, the additional selected platform-specific library being associated with the additional target platform;
linking the platform-independent instruction with a platform-specific instruction of the additional selected platform-specific library, the platform-specific instruction being a notification instruction for the additional target platform.
